(19) United States
(12) Patent Application Publication
(10) Pub. No.: US 2008/0150367 A1
(43) Pub. Date: Jun. 26, 2008

(54) Auxiliary Battery Pack

(76) Inventors: Seung Hee Oh, Dix Hills, NY (US); Jinoh Kim, Great Neck, NY (US)

Correspondence Address: GREENBERG TRAURIG, LLP, 200 PARK AVE., P.O. BOX 677, FLORHAM PARK, NJ, 07932, US

(21) Appl. No.: 11/613,335

(22) Filed: Dec. 20, 2006

(51) Int. Cl. H02J 7/02; H02J 7/00

(52) U.S. Cl. 307/80; 320/112

(57) ABSTRACT

An auxiliary battery pack for use with rechargeable battery powered portable electronic audio devices. The battery pack includes a housing, a portable direct current power source which is contained in the housing, and means for electrical interconnection of the portable direct current power source to the rechargeable battery of the audio device. The battery pack further includes a USB port for charging the auxiliary and rechargeable batteries of the battery pack and audio device. An audio jack connection is provided in the battery pack housing to permit audio output from the audio device when the battery pack is in use.

### FIELD OF THE INVENTION

The present invention relates to auxiliary battery packs for portable electronic audio devices.

### BACKGROUND OF THE INVENTION

Portable electronic audio devices such as the popular iPod® brand of products from Apple Computers, Inc. have found widespread use in a large variety of operating environments. Different models of such portable devices have varying playback times dictated by the factory installed rechargeable batteries, as specified by manufacturers of individual models. Even though battery technology is in a state of continual improvement, there will be times when any rechargeable battery must be recharged. Despite the conveniences offered by these portable audio devices, such recharging requirements are occasionally inconvenient or impossible.

It is therefore an object of the present invention to provide a multipurpose auxiliary battery pack offering a combination of features including auxiliary battery power for operating a portable electronic audio device and a charging mechanism for the auxiliary battery pack which obtains charging power from either an alternating current line voltage converter or direct current available from a personal computer via its USB port, all of which is housed in a battery pack which also incorporates a protective covering, for the portable device.

Protective auxiliary battery packs made in accordance with the present design have been shown to extend the battery life of some portable devices up to an additional 36 hours and some of the larger auxiliary battery packs can extend the battery life other portable audio-video devices up to 56 hours.

### SUMMARY OF THE INVENTION

A protective, multi-part auxiliary battery pack is provided for use with a battery powered portable electronic audio device. The battery pack includes a rechargeable auxiliary battery for providing a portable direct current power source which is effective for operating the portable electronic audio device.

The auxiliary battery pack also includes a battery charge-protection module electrically connected to the auxiliary battery. The battery charge-protection circuit is effective for safely recharging the auxiliary battery; preferably in a constant current, constant voltage mode.

The auxiliary battery pack also includes a multi-part housing having as a first portion a durable protective covering for the rechargeable auxiliary battery and the battery charge-protection module, and as a second portion a protective covering made of a resilient material which protects and cushions the portable electronic audio device, whereby the resilient covering also secures the portable device within the auxiliary battery pack. An electrical connection between the portable device contained in the resilient second covering portion of the housing and the auxiliary battery contained in the first durable portion of the housing is thereby maintained.

The auxiliary battery pack also includes means for electrical interconnection of a portable direct current power source to the auxiliary battery and to the audio device; and means for charging the auxiliary battery.

The battery pack has a first protective covering which is a durable container fabricated to hold the auxiliary battery and the battery charge-protection module and is made of metal and plastic coverings molded to contain the respective components. Its main functions include protecting the auxiliary battery and circuitry from leakage and short circuits.

The second portion of the housing is a resilient protective covering molded in a configuration designed to protect a pre-selected complementary portable electronic audio device. In preferred embodiments the resilient covering is a silicone rubber skin.

The means for charging the auxiliary battery is direct current provided by either an alternating current converter or direct current provided by a personal computer.

The auxiliary battery pack also has a universal serial bus port for interconnection of the rechargeable battery and its charge-protection module with a personal computer and which is effective for charging the auxiliary battery and synchronizing the portable electronic audio device with the computer.

Alternatively, the auxiliary battery pack may also use an AC/DC converter device for converting an alternating current power source to a direct current which is effective for charging the auxiliary battery pack and operating the audio device.

The battery pack may use a wide variety of rechargeable auxiliary batteries but a lithium-polymer battery is most preferred.

A preferred embodiment of the auxiliary battery pack will further include an audio jack connection in the battery pack housing which is effective for providing audio output from the portable device when the auxiliary battery pack is in use.

The auxiliary battery utilizes a battery charge-protection module which is effective for providing a combination of features including monitoring and control of proper charging, voltage, and current conditions, both from the line voltage or the alternative direct current from a computer; charging the auxiliary battery as needed, operating the audio device, and preventing overcharging of the auxiliary battery.

Other objects, features and advantages of the present invention will be apparent when the detailed descriptions of the preferred embodiments of the invention are considered with reference to the accompanying drawings, which should be construed in an illustrative and not limiting sense as follows.

### BRIEF DESCRIPTION OF THE DRAWINGS

FIG. 1 is a front elevation view of the auxiliary battery pack of the present invention.

FIG. 2 is a front perspective view of the device in FIG. 1.

FIG. 3 is a left side elevation view of the device.

FIG. 4 is a top elevation view of the device.

FIG. 5 is a bottom elevation view of the device.

FIG. 6 is a rear elevation view of the device.

FIG. 7 is a cross-sectional view of the device of FIG. 1, taken at reference line 7-7.

FIG. 8 is a schematic representation of the components of the device.

### DETAILED DESCRIPTION OF THE PREFERED EMBODIMENTS

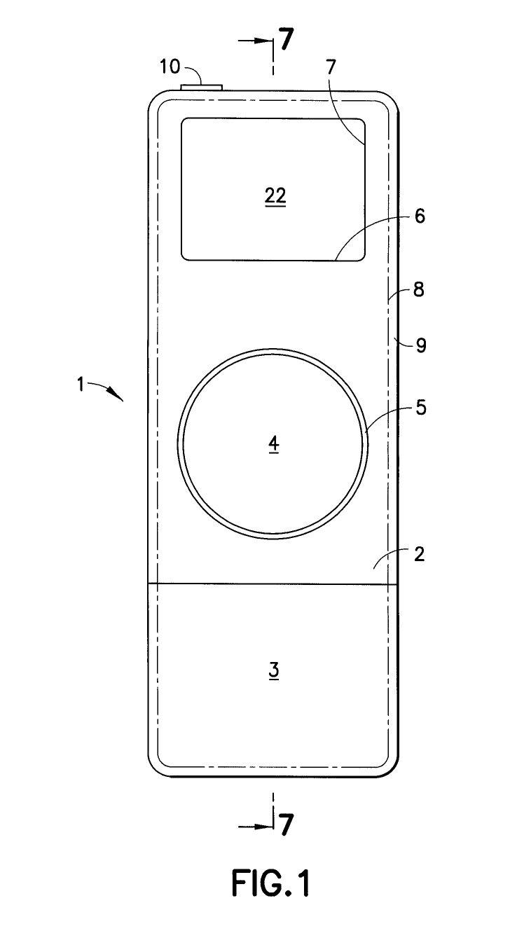

FIG. 1 depicts auxiliary battery pack device 1. The device in this view has a resilient protective covering 2 which is preferably made of silicone rubber. The bottom portion of the device is protected by durable covering 3 which is preferably metal or plastic molded to contain internal components such as the battery-protection circuitry. Relatively thin film 4 is made of the same material as resilient covering 2 but is sufficiently thin to permit a user to manually control an audio device within the housing, through the film 4, as may be desired. Many portable devices today have touchpad controls which may be readily operated inside the auxiliary pack in conjunction with thin film 4 of resilient covering 2. Film 5 is the transition film area which connects thin film 4 and resilient covering 2 and is made of the same material. In this figure, resilient covering 2 has a display view opening 7. It will be recognized that design features of resilient covering 2, such as view windows and touchpad films, will vary among different models or brands of complementary portable electronic devices.

Resilient protective covering 2, also known as a skin, is preferably made from a moldable, curable polysiloxane compound, also known as silicone rubber. In FIG. 1, a portable electronic audio device has not yet been inserted into the protective housing; therefore, a rear surface 22 of the battery pack within the device can be seen through view opening 7. A control switch on the upper portion of the portable electronic audio device can be reached through an opening or flap 10 on the top edge of resilient covering 2. In this and subsequent figures, the interrupted line represents a smooth edge transitioning from one surface to another, in this figure, for example, a smooth edge between a planar top surface transitions to each of its perpendicular sides.

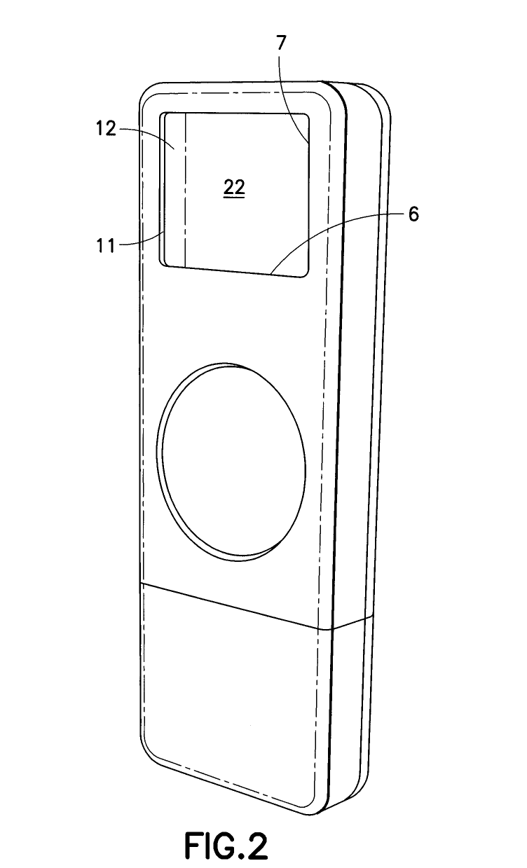

FIG. 2 depicts a front perspective view of the device shown in FIG. 1. In this view, view opening edge 6 is defined in greater detail by edge 11. Again, the rear surface of the battery pack 22 can be seen through view opening 7. Additionally in this view, left interior sidewall 12 can be seen in perspective because a portable electronic device has not yet been placed within the unit.

FIG. 3 is a left side elevation view of device 1, additionally depicting charge indicating means 13 which is typically a light emitting diode which preferably glows red while the unit is charging and glows green when the unit is fully charged.

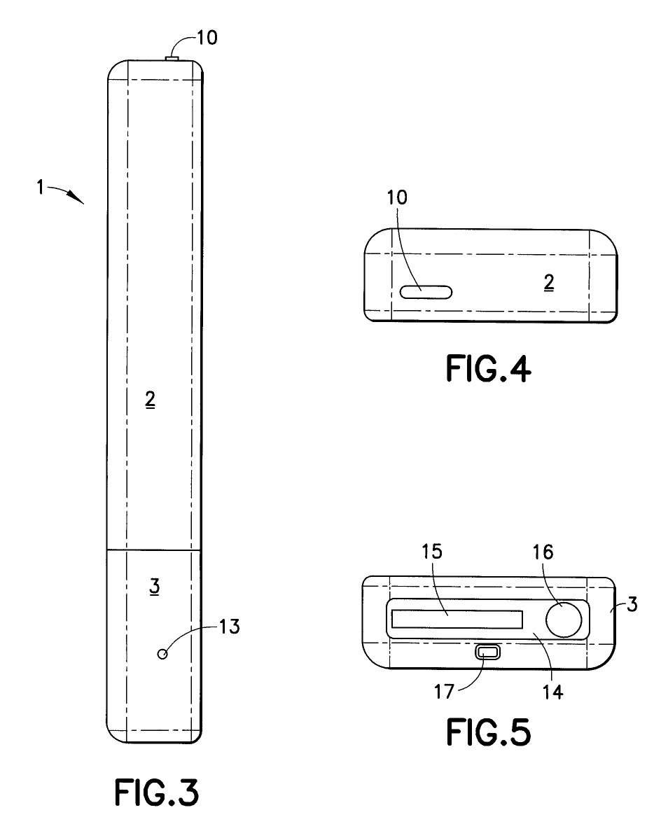

FIG. 4 is a top elevation view of the device showing resilient covering 2 on top of the device and having smoothly rounded edges towards the respective sides of the device, and further depicting optional flap or opening 10 for manually operating a control switch on the audio device.

FIG. 5 depicts a bottom elevation view of the device having durable covering 3 depicted with smoothly rounded edges towards the sides of the device and further depicting connecting means 14 which is typically a plastic connector, electrical connecting means 15 which is typically a 30 pin electrical connector, and further depicting audio output jack 16 for connecting headphones or the like. Durable covering 3 may be metal or durable thermoplastic shaped to contain its interior components. It will be recognized that some of the control and connection features depicted in these embodiments are intended to conform to the design and functional requirements of a selected portable electronic device, and therefore will vary with such device specifications.

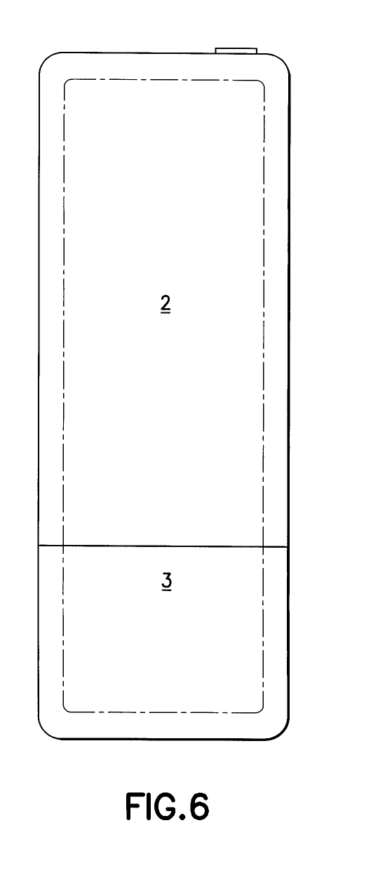

FIG. 6 is a rear elevation view of the device showing up a resilient covering to and lower durable covering 3.

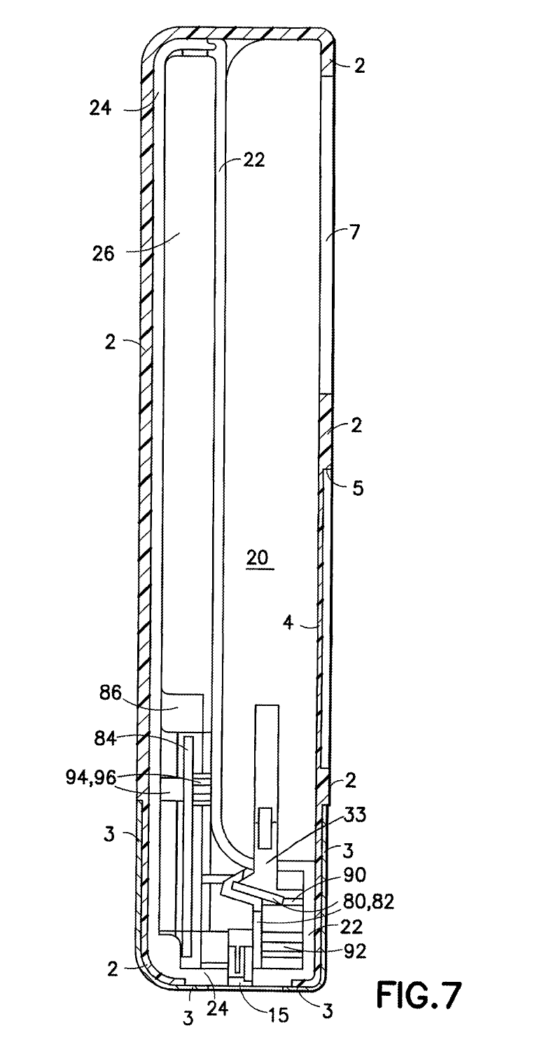

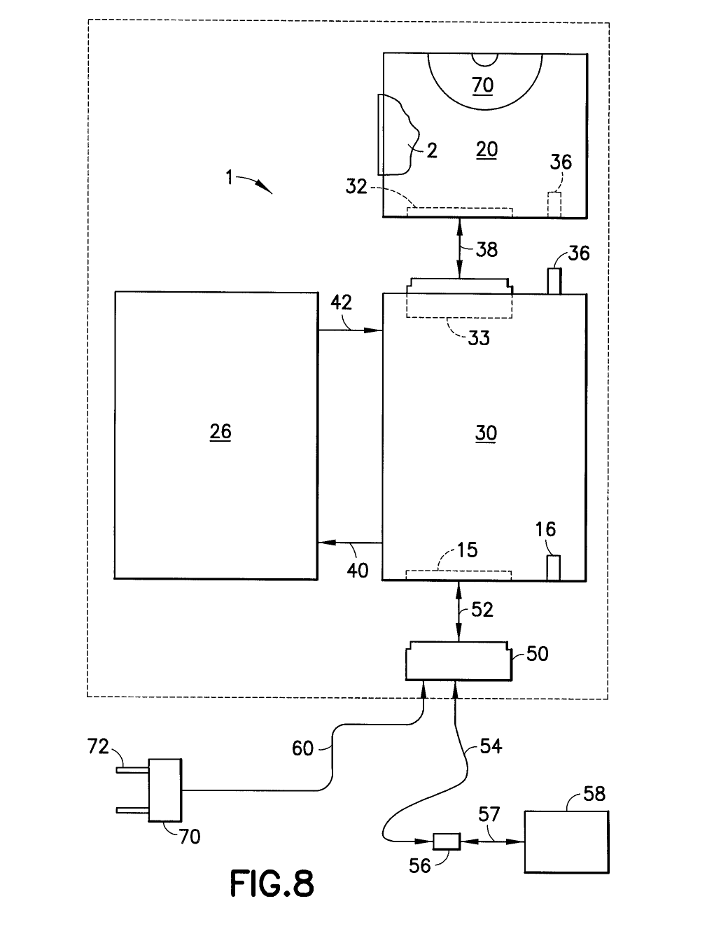

FIG. 7 depicts a cross sectional detail of the auxiliary battery pack depicted in FIG. 1 at reference line 7. This view additionally includes the cross-section of an installed portable electronic audio device 20, in this embodiment, an Apple IPOD brand device. As discussed previously, the present device has an upper resilient covering 2 which is permanently affixed, as by adhesive, cement, spot welding or friction grip, to the inner portion of the lower durable housing cover 3. In this figure it can be seen that resilient covering 2 on the rear and front surfaces of the device reach into the lower portion of durable housing 3 and are affixed to interior surfaces of durable housing 3. In this view thin-film 4 of resilient covering 2 is adjacent to the manual operating mechanism of portable device 20, and transition film area 5 is seen between thin film 4 and resilient covering 2. A display area on the portable electronic device may be seen through the protective skin at view opening 7. Rechargeable battery 26, which is preferably a lithium-polymer rechargeable battery, is seen in this view encased in a durable covering, preferably made of plastic, which has a rear surface 22 seen in FIGS. 1 and 2, and further covered with durable covering portion 24 which encapsulates the remainder of battery 26 and which is secured to the remainder of the auxiliary battery pack contained in lower durable housing 3. Also seen in FIG. 7 is a portion of insulating film 86 between the auxiliary battery and the charge-protection circuitry. Below battery 26 is printed circuit board 84 for control module 30 seen in FIG. 8. A number of conventional screw posts and mountings 90, 92, 94 and 96 are arranged to secure the housing, connector and circuitry components within lower durable housing 3. Also seen in this cross-section is conventional 30-pin connector 33 and its associated circuit boards 80 and 82.

FIG. 8 is a schematic representation of the interaction of the various components utilized in auxiliary battery pack 1 of the present invention, represented here within the hatched border. In this figure a portion of separately furnished portable electronic audio device 20 is shown installed in the device and covered with a small portion of resilient protective covering 2. Portable audio device 20 is electrically connected to the auxiliary rechargeable battery pack by its conventional 30-pin plug and connector arrangement represented by reference numerals 32 and 33. Bi-directional arrow 38 represents the power and synchronization connection between portable device 20 and auxiliary battery pack 1. Also shown is audio jack 36. Battery charge-protection module 30 is electrically connected to rechargeable auxiliary battery 26, first by connection means 40 representing the charging and charge maintenance functions of charge-protection module 30, and electrical connection 42 representing the capability of auxiliary rechargeable battery 26 to furnish operating power to the portable electronic audio device 20 through battery charge-protection module 30 by plug 33, link 38 and connector 32. Battery charge-protection module 30 also includes 30-pin receptacle 15 and audio jack receptacle 16 which generally duplicate respective receptacles 32 and 36 on the portable device 20. Receptacle 15 will engage a conventional 30 pin connector 50 in one of the following alternative configurations. In both instances, 30-pin connector 50 is electrically connected to module 30 by bidirectional line 52 which represents the ability of the device to be charged with direct electrical current as well as its ability to synchronize the portable device with a personal computer 58. In a first embodiment where the device will be used with a personal computer, 30-pin connector 50 is attached to USB cable 54 which is effective for charging and synchronization of the devices. USB cable 54 has USB plug 56, and bidirectional electrical and synchronization connection represented by element 57 connected to personal computer 58. In the alternative embodiment, 30-pin connector 50 is electrically connected to direct current cable 60 which is connected to conventional AC/DC converter 70 which may be plugged into household line current via plug 72.

Rechargeable batteries and particularly the lithium-polymer batteries preferred for use in the subject auxiliary battery pack design require conventional charge protection circuitry for both safety and functional operation. Such circuitry is typically supplied by the battery manufacturer as a component part of a rechargeable battery system.

The preferred power supply is referred to as a battery charge-protection module which expression is intended to encompass a battery safety circuit, a power boost circuit, a control converter, a charging indicator and charging management means. These functions utilize conventional control logic, as is provided by commercially available integrated circuit components. The battery charge-protection operates in the following typical manner.

The battery safety circuit combines over-charge, over-discharge, and short-circuit protection. When the battery voltage exceeds about 4.25V, the logic control turns off the charging process. When the battery voltage is below 2.7V, the low voltage indication will turn off battery discharging. When short circuit conditions are experienced, the logic controller also will automatically turn off battery discharging.

When the device is alternatively operated using an AC line converter adapter or the USB port of a computer, the boost circuit is no longer needed and will turn off. The current is divided into two parts. A first portion of the current operates the portable electronic audio device, while the other portion charges the external auxiliary battery through a conventional charging management module. The charging management module uses, for example, a current sensor resistor. During charging, voltage on the resistor controls the charging current. When the battery voltage reaches 4.2V charging will stop automatically. It is useful to include a light emitting diode charging indicator which glows red during charging and green when the device is fully charged.

The auxiliary battery pack of the present design can utilize a conventional USB cable such as the USB-to-30PIN cable supplied with iPod brand products. The USB end of this cable can be connected to an AC adapter designed to convert line power to direct current. The same cable can be utilized to synchronize the portable electronic audio device with music, video or similar media content on a personal computer and it will obtain auxiliary battery recharging power from the same computer by attaching the cable to the USB port of the computer.

It is preferred that the rechargeable battery utilized in the auxiliary battery pack device be a conventional lithium-polymer battery which operates at about 3.7 V and about 750 to 2700 mAh capacity. Such batteries can recharge in approximately 3 to 6 hours and can offer a variety of playback times for portable audio and video devices. An example of a battery which may be used in conjunction with an iPod video device, is an ELITOP brand battery model HY-I-603 manufactured by Shenzhen Elite Electronic Co., Ltd. Similar auxiliary batteries are available for use in connection with other models or brands of portable devices. The aforementioned HY-I-603 model has a nominal voltage of 3.7 V, a battery capacity greater than or equal to 2700 mAh, and an internal battery impedance of less than 180 m-ohms. Such batteries typically utilize a constant current, constant voltage method of recharging. Such batteries also utilize a conventional cell battery protection circuit module discussed above which is sometimes referred to herein as a battery charging-protection circuit. Such a circuit protects the cell battery from overcharging, over discharging, or experiencing short-circuits. It is also preferred that the cell battery be connected to the battery charging-protection circuit as well as the remaining housing parts by conventional ultrasonic welding or spot welding.

The portable auxiliary battery packs discussed herein are designed to match commercially available portable devices. For example an auxiliary battery pack designed to complement the iPod NANO brand device will have approximate dimensions of 1.7″×4.6″×0.6″. Larger auxiliary battery packs can be used with other portable devices such as those having video playback capabilities and such a battery pack might have approximate dimensions of 2.6″×4.8″×1.0″.

The invention now being fully described, it will be apparent to one of ordinary skill in the art that many changes and modifications can be made thereto without departing from the spirit or scope of the invention as set forth herein.

1. An auxiliary battery pack for use with a rechargeable battery powered portable electronic audio device comprising:
a. an auxiliary battery for providing a portable direct current power source effective for operating a portable electronic audio device;
b. a battery charge-protection circuit electrically connected to auxiliary battery, the battery charge-protection circuit effective for protecting the rechargeable battery, avoiding overcharge and damage to the auxiliary battery;
c. a multi-part housing having as a first portion a durable protective covering for the auxiliary battery and the battery charge-protection circuit, and as a second portion a protective covering made of a resilient material which protects and cushions the portable electronic audio device, whereby the second resilient covering secures and maintains an electrical connection between the portable device contained in the resilient second covering portion of the housing and the auxiliary battery contained in the first durable portion of the housing;
d. means for electrical interconnection of the portable direct current power source to the rechargeable battery of the audio device; and
e. means for charging the auxiliary battery and the portable electronic audio device battery.

2. A battery pack as in claim 1 wherein the first protective covering is a durable holder for the auxiliary battery and charge-protection circuit and is selected from metal and plastic coverings.

3. A battery pack as in claim 1 wherein the second resilient protective covering is silicone rubber.

4. A battery pack as in claim 1 wherein the means for charging both batteries is a direct current provided by an alternating current converter or direct current provided by a personal computer.

5. A battery pack as in claim 4 further comprising a universal serial bus port for interconnection of the battery pack and charge-protection circuit with a personal computer and effective for charging the batteries and synchronizing the portable electronic audio device.

6. A battery pack as in claim 4 further comprising means for converting an alternating current power source to a direct current which is effective for charging the battery pack and audio device.

7. A battery pack as in claim 1 wherein the auxiliary battery is a lithium-ion battery.

8. A battery pack as in claim 1 further comprising an audio jack connection in the battery pack housing effective for providing audio output from the portable device when the battery pack is in use.

9. A battery pack as in claim 1 wherein the battery charge-protection circuit has means for safely charging the auxiliary battery with constant current-constant voltage.

10. A battery pack as in claim 1 wherein the battery charge-protection circuit is effective for imposing proper charging voltage/current from the line voltage; charging the auxiliary battery and the device battery, operating the audio device, and preventing overcharging of the auxiliary battery.
